(19) United States
(12) Patent Application Publication
(10) Pub. No.: US 2022/0122613 A1
(43) Pub. Date: Apr. 21, 2022

(54) METHODS AND SYSTEMS FOR DETECTING PASSENGER VOICE DATA

(71) Applicant: TOYOTA MOTOR ENGINEERING & MANUFACTURING NORTH AMERICA, INC., Plano, TX (US)

(72) Inventor: Masashi NAKAGAWA, Sunnyvale, CA (US)

(73) Assignee: TOYOTA MOTOR ENGINEERING & MANUFACTURING NORTH AMERICA, INC., Plano, TX (US)

(21) Appl. No.: 17/074,997

(22) Filed: Oct. 20, 2020

(51) Int. Cl. G10L 17/10; G06K 9/00

(52) U.S. Cl. CPC G10L 17/10; G06K 9/00288; G06K 9/00838

(57) ABSTRACT

A method detecting passenger specific voice data based on vehicle operating conditions that are set based on the passenger specific voice data are provided. The method includes obtaining, using a sensor operating in association with the computing device, image data associated with a passenger in the vehicle, obtaining an identification of the passenger based on the image data, and retrieving one or more voice characteristics of the passenger based on the identification. The method also includes selecting, by the computing device, an operating condition for an additional sensor of the vehicle based on the one or more voice characteristics of the passenger, and detecting, by the additional sensor that operates in the operating condition, voice data specific to the passenger.

### TECHNICAL FIELD

The present disclosure described herein generally relate to detecting passenger voice data, and more specifically, to detecting passenger voice data by selecting an operating condition for a vehicle component based on voice characteristics of passengers.

### BACKGROUND

Conventional vehicle systems are configured to detect human speech and perform various actions based on one or more instructions or comments included in the detected speech, e.g., initiate a call with a device that is external to the vehicle, start the vehicle, turn on the vehicle's headlights, and so forth. In this way, these systems include a number of features accessible to a user of these systems. However, conventional systems do not include the functionality to adjust settings of one or more vehicle components based on voice attributes of different passengers.

Accordingly, a need exists for a vehicle system that tailors the operation of particular components of a vehicle system based on the voice characteristics of various passengers.

### SUMMARY

In one embodiment, a method for detecting passenger voice data based on vehicle operating conditions that are selected based on passenger voice characteristics, is provided. The method includes obtaining, using a sensor operating in association with the computing device, image data associated with a passenger in the vehicle, obtaining an identification of the passenger based on the image data, and retrieving one or more voice characteristics of the passenger based on the identification. The method also includes selecting, by the computing device, an operating condition for an additional sensor of the vehicle based on the one or more voice characteristics of the passenger, and detecting, by the additional sensor that operates in the operating condition, voice data specific to the passenger.

In another embodiment, a system that is configured to detect passenger voice data based on vehicle operating conditions that are selected based on passenger voice characteristics, is provided. The system includes a sensor, an additional sensor, a processor (each of which is included as part of the vehicle), and one or more non-transitory memory modules communicatively coupled to the processor of the vehicle and configured to store machine-readable instructions. These machine-readable instructions, when executed by the processor, cause the processor to obtain, using the sensor operating in associated with the processor, image data associated with a passenger in the vehicle, obtain an identification of the passenger based on the image data, retrieve one or more voice characteristics of the passenger based on the identification, select, based on the detected image data, an operating condition for an additional, sensor of the vehicle based on the one or more voice characteristics of the passenger, and detect, using the additional sensor set under the operating condition, voice data specific to the passenger.

In yet another embodiment, a vehicle for detecting passenger voice data based on vehicle operating conditions that are selected based on passenger voice characteristics, is provided. The vehicle includes a sensor, an additional sensor, and a processor. The processor is configured to obtain, using the sensor operating in associated with the processor, image data associated with a passenger in the vehicle, obtain an identification of the passenger based on the image data, retrieve one or more voice characteristics of the passenger based on the identification, select, based the image data, an operating condition for the additional sensor of the vehicle based on the one or more voice characteristics of the passenger, and detect, by the additional sensor that operates in the operating condition, voice data specific to the passenger.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an interior of the vehicle including a vehicle system that includes one or more vehicle components that are adjustable based on voice characteristics of passengers, according to one or more embodiments described and illustrated herein;

FIG. 2 schematically depicts non-limiting components of the vehicle system as described in the present disclosure, according to one or more embodiments described and illustrated herein;

FIG. 3 schematically depicts a flowchart for detecting voice data specific to different passengers by adjusting operating conditions of one or more components of the vehicle system based on voice characteristics of these passengers, according to one or more embodiments described and illustrated herein;

FIG. 4 schematically depicts a passenger seated in the driver's seat of the vehicle and in close proximity to the vehicle system described herein that includes one or more vehicle components that are adjustable based on voice characteristics of passengers, according to one or more embodiments described and illustrated herein;

FIG. 5 schematically depicts the vehicle system of the present disclosure that is configured to detect voice data specific to the passenger seated in the driver's seat by adjusting or setting an operating condition of one or more vehicle components based on the voice characteristics of the passenger seated in the driver's seat, according to one or more embodiments described and illustrated herein;

FIG. 6 schematically depicts a passenger seated in passenger seat of the vehicle and in close proximity to the vehicle system described herein that includes one or more vehicle components that are adjustable based on voice characteristics of passengers, according to one or more embodiments described and illustrated herein; and

FIG. 7 schematically depicts the vehicle system of the present disclosure that is configured to detect voice data specific to the passenger seated in the passenger seat by adjusting or setting an operating condition of one or more vehicle components based on the voice characteristics of the passenger seated in the passenger seat, according to one or more embodiments described and illustrated herein.

### DETAILED DESCRIPTION

The embodiments disclosed herein describe methods and systems for detecting passenger voice data based on vehicle operating conditions that are selected to correspond with passenger voice characteristics. For example, the vehicle system described herein may obtain images of a passenger in a vehicle, obtain the identity of this passenger, and retrieve one or more voice characteristics of the passenger. Based on one or more of these characteristics, the vehicle system may select an operating condition for one or vehicle components associated with the system, and detect voice data specific to the passenger. In this way, the vehicle system tailors the operation of one or more vehicle components (e.g., a microphone) to suit or correspond with the voice characteristics of passengers. Such a vehicle system reduces the occurrence of instances in which the microphone fails to capture voice data of passengers and improves the overall accuracy with which voice data of various passengers (with varying voice characteristics) is captured and analyzed.

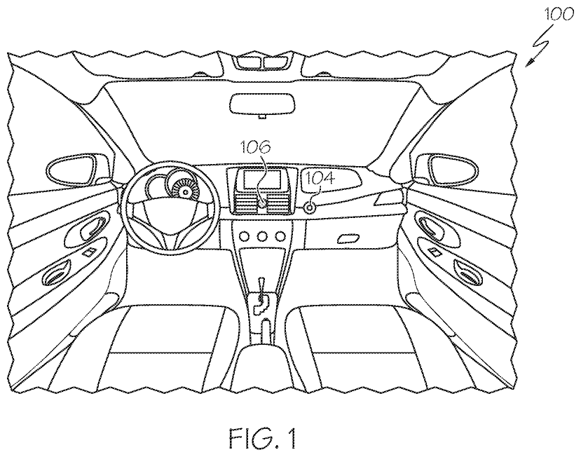

Referring now to the drawings, FIG. 1 schematically depicts an interior of the vehicle including a vehicle system that includes one or more vehicle components that are adjustable based on voice characteristics of passengers, according to one or more embodiments described and illustrated herein.

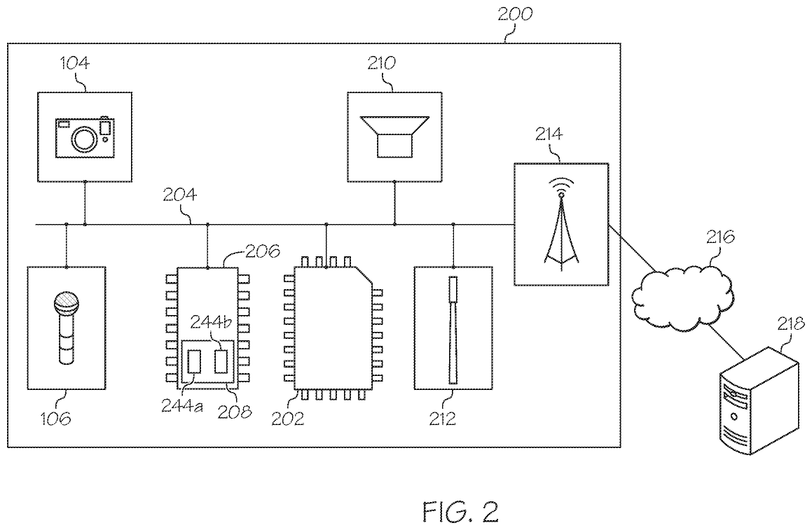

As illustrated, the vehicle 100 includes various components as part of a vehicle system 200 (not shown in FIG. 1, but depicted in FIG. 2) usable for detecting voice data specific to passengers. The interior portion of the vehicle 100 includes a camera 104 and a microphone 106, both of which may be mounted or installed near one or more air vents of the vehicle 100. It is contemplated that the camera 104 and the microphone 106 may be mounted in a plurality of other locations in the interior of the vehicle. The camera 104 may be configured to capture one or more images of individuals and/or objects in the interior of the vehicle 100 upon activation. In embodiments, the camera 104 may be automatically activated upon the starting of the vehicle 100.

Alternatively, the camera 104 may be manually turned on by, e.g., an individual operating a tactile input hardware (not shown) such as a button or switch. The microphone 106 may be configured for detect voice data specific to one or more passengers located in the interior of the vehicle. In embodiments, one or more settings associated with the microphone 106 may be adjusted upon completion of the capturing of the one or more images of an individual located in the interior of the vehicle. Specifically, in embodiments, upon the capturing one or more images of a passenger, the vehicle system 200 (not shown in FIG. 1, but depicted in FIG. 2) may select an operating condition or setting for the microphone 106 that is based on the voice characteristics of passenger (e.g., whose image may be captured by the camera 104). In this way, an operating condition of a vehicle component (e.g., the microphone 106) may be adjusted, e.g., the microphone 106 may be configured to accurately and effectively capture voice data that is specific to the passenger. The operation of the vehicle system 200 will be described in further detail below.

FIG. 2 schematically depicts non-limiting components of a vehicle system 200, according to one or more embodiments shown herein. It should be understood that the vehicle system 200 may be integrated within the vehicle 100.

The vehicle system 200 includes one or more processors 202, a communication path 204, one or more memory modules 206, a speaker 210, a camera 104, a microphone 106, a satellite antenna 212, a network interface hardware 214, a communication network 216, and a server 218. The various components of the vehicle system 200 and the interaction thereof will be described in detail below.

Each of the one or more processors 202 may be any device capable of executing machine readable instructions. Accordingly, each of the one or more processors 202 may be a controller, an integrated circuit, a microchip, a computer, or any other computing device. The one or more processors 202 are communicatively coupled to the other components of the vehicle system 200 by the communication path 204. Accordingly, the communication path 204 may communicatively couple any number of processors with one another, and allow the modules coupled to the communication path 204 to operate in a distributed computing environment. Specifically, each of the modules may operate as a node that may send and/or receive data.

The communication path 204 may be formed from any medium that is capable of transmitting a signal such as, for example, conductive wires, conductive traces, optical waveguides, or the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 204 communicatively couples the various components of the vehicle system 200. As used herein, the term “communicatively coupled” means that coupled components are capable of exchanging data signals with one another such as, for example, electrical signals via conductive medium, electromagnetic signals via air, optical signals via optical waveguides, and the like.

As noted above, the vehicle system 200 includes the one or more memory modules 206. Each of the one or more memory modules 206 of the vehicle system 200 is coupled to the communication path 204 and communicatively coupled to the one or more processors 202. The one or more memory modules 206 may comprise RAM, ROM, flash memories, hard drives, or any device capable of storing machine readable instructions such that the machine readable instructions may be accessed and executed by the one or more processors 202. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 206. In some embodiments, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

In embodiments, the one or more memory modules 206 include a speech assessment module 208 that processes speech input signals received from the microphone 106 and/or extracts speech information from such signals, as will be described in further detail below. Furthermore, the one or more memory modules 206 include machine readable instructions that, when executed by the one or more processors 202, cause the vehicle system 200 to perform various actions. The speech assessment module 208 includes voice input analysis logic 244a and response generation logic 244b.

The voice input analysis logic 244a and response generation logic 244b may be stored in the one or more memory modules 206. In embodiments, the voice input analysis logic 244a and response generation logic 244b may be stored on, accessed by and/or executed on the one or more processors 202. In embodiments, the voice input analysis logic 244a and response generation logic 244b may be executed on and/or distributed among other processing systems to which the one or more processors 202 are communicatively linked. For example, at least a portion of the voice input analysis logic 244a may be located onboard the vehicle 100. In one or more arrangements, a first portion of the voice input analysis logic 244a may be located onboard the vehicle 100, and a second portion of the voice input analysis logic 244a may be located remotely from the vehicle 100 (e.g., on a cloud-based server, a remote computing system, and/or the one or more processors 202). In some embodiments, the voice input analysis logic 244a may be located remotely from the vehicle 100.

The voice input analysis logic 244a may be implemented as computer readable program code that, when executed by a processor, implement one or more of the various processes described herein. The voice input analysis logic 244a may be a component of one or more processors 202, or the voice input analysis logic 244a may be executed on and/or distributed among other processing systems to which one or more processors 202 is operatively connected. In one or more arrangements, the voice input analysis logic 244a may include artificial or computational intelligence elements, e.g., neural network, fuzzy logic or other machine learning algorithms. Other operating processes of the voice input analysis logic 244a are also contemplated.

The voice input analysis logic 244a may receive one or more occupant voice inputs from one or more vehicle occupants of the vehicle 100. The one or more occupant voice inputs may include any audial data spoken, uttered, pronounced, exclaimed, vocalized, verbalized, voiced, emitted, articulated, and/or stated aloud by a vehicle occupant. The one or more occupant voice inputs may include one or more letters, one or more words, one or more phrases, one or more sentences, one or more numbers, one or more expressions, and/or one or more paragraphs, etc.

The one or more occupant voice inputs may be sent to, provided to, and/or otherwise made accessible to the voice input analysis logic 244a. The voice input analysis logic 244a may be configured to analyze the occupant voice inputs. The voice input analysis logic 244a may analyze the occupant voice inputs in various ways. For example, the voice input analysis logic 244a may analyze the occupant voice inputs using any known natural language processing system or technique. Natural language processing may include analyzing each user's notes for topics of discussion, deep semantic relationships and keywords. Natural language processing may also include semantics detection and analysis and any other analysis of data including textual data and unstructured data. Semantic analysis may include deep and/or shallow semantic analysis. Natural language processing may also include discourse analysis, machine translation, morphological segmentation, named entity recognition, natural language understanding, optical character recognition, part-of-speech tagging, parsing, relationship extraction, sentence breaking, sentiment analysis, speech recognition, speech segmentation, topic segmentation, word segmentation, stemming and/or word sense disambiguation. Natural language processing may use stochastic, probabilistic and statistical methods.

The voice input analysis logic 244a may analyze the occupant voice inputs to determine whether one or more commands and/or one or more inquiries are included in the occupant voice inputs. A command may be any request to take an action and/or to perform a task. An inquiry includes any questions asked by a user (e.g., driver or passenger), comments made by a user, instructions provided by the user, and/or the like. The voice input analysis logic 244a may analyze the vehicle operational data in real-time or at a later time. As used herein, the term “real time” means a level of processing responsiveness that a user or system senses as sufficiently immediate for a particular process or determination to be made, or that enables the processor to keep up with some external process.

Still referring to FIG. 2, the vehicle system 200 includes the speaker 210 for transforming data signals from the vehicle system 200 into mechanical vibrations, such as in order to output audible prompts or audible information from the vehicle system 200. The speaker 210 is coupled to the communication path 204 and communicatively coupled to the one or more processors 202.

Still referring to FIG. 2, the vehicle system 200 optionally includes a satellite antenna 212 coupled to the communication path 204 such that the communication path 204 communicatively couples the satellite antenna 212 to other modules of the vehicle system 200. The satellite antenna 212 is configured to receive signals from global positioning system satellites. Specifically, in one embodiment, the satellite antenna 212 includes one or more conductive elements that interact with electromagnetic signals transmitted by global positioning system satellites. The received signal is transformed into a data signal indicative of the location (e.g., latitude and longitude) of the satellite antenna 212 or an object positioned near the satellite antenna 212, by the one or more processors 202.

Additionally, it is noted that the satellite antenna 212 may include at least one of the one or more processors 202 and the one or memory modules 206. In embodiments where the vehicle system 200 is coupled to a vehicle, the one or more processors 202 execute machine readable instructions to transform the global positioning satellite signals received by the satellite antenna 212 into data indicative of the current location of the vehicle. While the vehicle system 200 includes the satellite antenna 212 in the embodiment depicted in FIG. 2, the vehicle system 200 may not include the satellite antenna 212 in other embodiments, such as embodiments in which the vehicle system 200 does not utilize global positioning satellite information or embodiments in which the vehicle system 200 obtains global positioning satellite information from various external devices via the network interface hardware 214.

As noted above, the vehicle system 200 may include the network interface hardware 214 for communicatively coupling the vehicle system 200 with a server 218, e.g., via communication network 216. The network interface hardware 214 is coupled to the communication path 204 such that the communication path 204 communicatively couples the network interface hardware 214 to other modules of the vehicle system 200. The network interface hardware 214 may be any device capable of transmitting and/or receiving data via a wireless network. Accordingly, the network interface hardware 214 may include a communication transceiver for sending and/or receiving data according to any wireless communication standard. For example, the network interface hardware 214 may include a chipset (e.g., antenna, processors, machine readable instructions, etc.) to communicate over wireless computer networks such as, for example, wireless fidelity (Wi-Fi), WiMax, Bluetooth, IrDA, Wireless USB, Z-Wave, ZigBee, or the like. In some embodiments, the network interface hardware 214 includes a Bluetooth transceiver that enables the vehicle system 200 to exchange information with the server 218 via Bluetooth communication.

The communication network 216 enables the communication of data between the vehicle system 200 and various external devices according to mobile telecommunication standards. The communication network 216 may further include any network accessible via the backhaul networks such as, for example, wide area networks, metropolitan area networks, the Internet, satellite networks, or the like. In embodiments, the communication network 216 may include one or more antennas, transceivers, and processors that execute machine readable instructions to exchange data over various wired and/or wireless networks.

Accordingly, the communication network 216 may be utilized as a wireless access point by the network interface hardware 214 to access one or more servers (e.g., a server 218). The server 218 generally includes processors, memory, and chipset for delivering resources via the communication network 216. Resources may include providing, for example, processing, storage, software, and information from the server 218 to the vehicle system 200 via the communication network 216.

The camera 104 of the vehicle system 200 may be coupled to a communication path 204, which provides signal interconnectivity between various components of the vehicle system 200. The camera may be any device having an array of sensing devices capable of detecting radiation in an ultraviolet wavelength band, a visible light wavelength band, or an infrared wavelength band. The camera may have any resolution. In some embodiments, one or more optical components, such as a mirror, fish-eye lens, or any other type of lens may be optically coupled to the camera. In embodiments, the camera may have a broad angle feature that enables capturing digital content within a 150 degree to 180 degree arc range. Alternatively, the camera may have a narrow angle feature that enables capturing digital content within a narrow arc range, e.g., 60 degree to 90 degree arc range. In embodiments, the one or more cameras may be capable of capturing high definition images in a 720 pixel resolution, a 1080 pixel resolution, and so forth. Alternatively or additionally, the camera may have the functionality to capture a continuous real time video stream for a predetermined time period.

The microphone 106 of the vehicle system 200 is usable for transforming acoustic vibrations received by the microphone into a speech input signal. The microphone 106 is coupled to the communication path 204 and communicatively coupled to the one or more processors 202. As will be described in further detail below, the one or more processors 202 may process the speech input signals received from the microphone 106 and/or extract speech information from such signals.

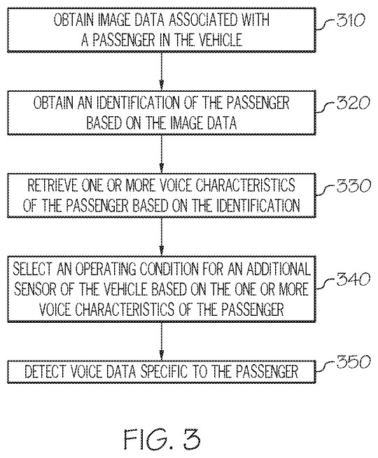

FIG. 3 schematically depicts a flowchart for detecting voice data specific different passengers by adjusting operating conditions of one or more components of the vehicle system based on voice characteristics of these passengers, according to one or more embodiments described and illustrated herein.

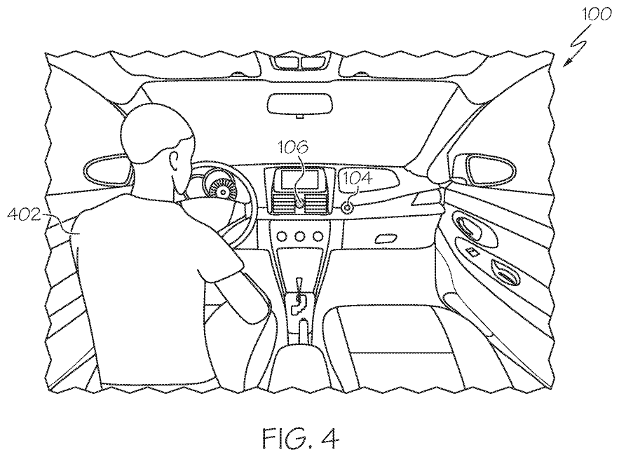

In embodiments, in block 310, the vehicle system 200 obtains, using a sensor (e.g., the camera 104) operating in association with a computing device, image data of a passenger in a vehicle 100. For example, as depicted in FIG. 4, the vehicle system 200 may obtain one or more images (e.g., from one or more angles) of a driver 402 seated in the driver's seat. In this example, the driver 402 may have seated himself in the interior of the vehicle 100 and started the vehicle 100, as a result of which the camera 104 may be activated. In embodiments, the camera 104 may capture one or more images of the driver 402 in real time, e.g., immediately after the vehicle 100 is turned on. Alternatively, the camera 104 may be activated after the vehicle 100 is unlocked by the driver 402 (e.g., using a key fob, an application on a smartphone of a user, and so forth).

In embodiments, in block 320, the vehicle system 200 may obtain an identification of the passenger based on the image data. In embodiments, the vehicle system 200 may detect the identity of the driver 402 by comparing the one or more images of the driver 402 captured by the camera 104 with data stored in the one or more memory modules 206 of the vehicle system 200. In embodiments, the one or more memory modules 206 may store data describing the identity of the individual whose image was captured (e.g., the driver 402). For example, the one or more memory modules 206 may store data such as the individual's name, age, images of the individual from various angles, voice characteristics of the individual, and so forth. The data may be stored in a database that is part of or associated with the one or more memory modules 206. In embodiments, the one or more processors 202 may perform a comparison operation between the facial characteristics included in the captured one or more images of the individual and the individual's images that are stored in the one or more memory modules 206. For example, the comparison operation may include the one or more processors 202 determining whether facial characteristics of the individual that are included in the one or more captured images have a threshold level of similarity with the images of the individual stored in the one or more memory modules 206. If the similarity threshold is satisfied, the one or more processors 202 may access a profile that is specific to the individual (e.g., the driver 402). This profile may include various voice characteristics of the driver 402. A similar comparison operation may be performed by one or more devices that are external to the vehicle system 200, e.g., the server 218. Upon completion of the comparison operation, the server 218 may access a profile specific to the individual and communicate data specific to the individual to the vehicle system 200 via the communication network 216. Alternatively or additionally, various other external devices (working in conjunction with the server 218 and/or the vehicle system 200) may perform the comparison operation.

Additionally, in embodiments, if the one or more images of an individual that are captured by the camera 104 do not match any images that are stored in the one or more memory modules 206, the vehicle system 200 may begin building a new profile of an individual by storing the captured images in the one or more memory modules 206. Similarly, such a profile may be built by devices that are external to the vehicle system 200, e.g., the server 218 or the server 218 operating in conjunction with various other devices. In embodiments, the building of the profile may be occur automatically and in real time. In embodiments, for an individual whose profile is being built and whose voice characteristics are not readily available, the vehicle system 200 may select a plurality of default settings or default operating conditions of various vehicle components (e.g., the microphone 106) of the vehicle 100.

Thereafter, in embodiments, in block 330, the vehicle system 200 may retrieve one or more voice characteristics of the passenger based on the identification. For example, the one or more processors 202 of the vehicle system 200 may retrieve one or more voice characteristics that are specific to the driver 402 upon the one or more processors 202 determining the identity of the driver 402, as described above. In embodiments, the one or more processors 202 may retrieve various voice characteristics such as pitch, speech rate (e.g., speed of speech), tone, texture, intonation, loudness (e.g., a typical decibel range of an individual), and so forth, from the data stored in the one or more memory modules 206. It is contemplated that other voice characteristics may also be retrieved. Alternatively or additionally, the vehicle system 200 may receive these voice characteristics from the server 218 via the communication network 216.

In embodiments, in block 340, the vehicle system 200 may select an operating condition for an additional sensor (e.g., the microphone 106) of the vehicle 100 based on the one or more voice characteristics of the passenger (e.g., the driver 402). In embodiments, the one or more processors 202 may communicate with the microphone 106 via the communication path 204 of the vehicle system 200 and select a particular setting for the microphone 106 based on the retrieved voice characteristics of the driver 402. In embodiments, these characteristics may include the pitch, tone, speech rate (e.g., speed of speech), intonation, loudness, and so forth. For example, the voice characteristics of the driver 402 may indicate that his speech rate is high and that he has a tendency to speak loudly. Additionally, the driver 402 may have a high pitched voice.

It is noted that, in embodiments, the voice characteristics retrieved by the one or more processors 202 may include numerical values for each of speech rate, pitch, tone, intonation, loudness, and so forth. As such, in embodiments, the one or more processors 202 may select an operating condition for the microphone 106 that corresponds to a pitch value (or pitch value range) that is specific to the voice pitch of the driver 402. It is noted that, in embodiments, the selection of the operating condition of the microphone 106 may occur automatically, in real time, and without user intervention. Alternatively, in embodiments, the one or more processors 202 may select an operating condition for the microphone 106 based a combination of one or more of the pitch value, tone value, loudness value (among other voice characteristics). In embodiments, one or more voice characteristics may be analyzed by the vehicle system 200, simultaneously or sequentially, to select an operating condition.

In embodiments, in block 350, the microphone 106 may detect, by the additional sensor (e.g., the microphone 106) that operates in the operating condition, voice data specific to the passenger. Specifically, the microphone 106 may be selected to function in an operating condition that corresponds to a pitch value associated with the driver 402. For example, as stated, if the driver has a high pitched voice (which may correspond to a high pitch value), a setting of the microphone 106 corresponding to this high pitch value may be set. In other embodiments, the microphone 106 may be set to function in an operating condition corresponding to a speech rate of the driver 402. For example, as stated above, the retrieved voice characteristics of the driver 402 may indicate that the driver 402 has a tendency to speak very fast (which may correspond to a high speech rate value). As such, in this embodiment, the microphone 106 may be set to function in an operating condition such that the microphone 106 detects the voice of the driver 402, e.g., every fifth of a second. In other words, the microphone 106 may be set to detect sounds emerging from the driver 402 within a short time frame. It is further noted that the one or more processors 202 may also be configured to analyze the sounds emerging from the driver 402 at short time intervals (e.g., every fifth of a second, and the like) in order to ensure that all of the content included in the sounds emerging from the driver 402 are adequately analyzed.

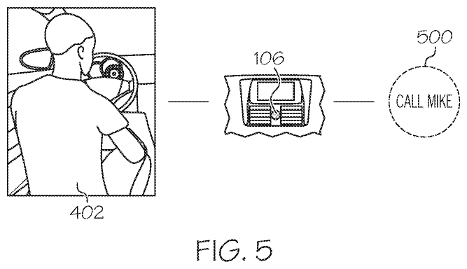

In FIG. 5, the real time operation of the microphone 106 is depicted. Specifically, after the one or more processors 202 select an operating condition for the microphone 106 based on the voice characteristics of the driver 402 (e.g., speech rate value, pitch rate, and/or other characteristics), the microphone 106 may detect voice data such as “Call Mike” (Instruction 500), which may be an instruction to the vehicle system 200 to initiate a telephone call to an acquaintance of the driver 402. As the setting of the microphone 106 corresponds with the voice characteristics of the driver 402, the vehicle system 200 will be able to accurately capture the voice data from the driver 402, effectively analyze the captured data, and perform an action (e.g., initiate a call to a friend). Additionally, the vehicle system 200 may also have the functionality to partially mute or filter sounds that are, e.g., extraneous to the conversation between the driver 402 and his acquaintance Mike. For example, the vehicle system 200 may include a “mute feature” that prevents sounds that may be heard from other vehicles, blaring horns, and so forth, that interfere with the conversation between the driver 402 and his acquaintance. Specifically, the vehicle system 200 may filter these sounds such that his acquaintance may only hear speech from the driver 402.

It is further noted that the vehicle system 200 may perform the steps outlined in the flow chart depicted in FIG. 3 with respect to one or more additional passengers that are located within the vehicle 100. In embodiments, the camera 104 of the vehicle system 200 may obtain additional image data associated with an additional passenger in the vehicle 100.

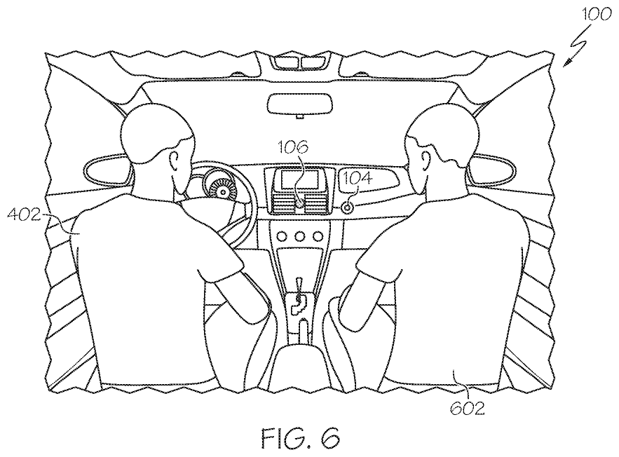

For example, as depicted in FIG. 6, the camera 104 may obtain image data associated with traveler 602 seated in the passenger seat of the vehicle 100. The camera 104 may capture one or more images of the traveler 602 in real time, e.g., after the traveler 602 seats himself in the passenger seat. Thereafter, the vehicle system 200 may obtain an identification 1 (e.g., additional identification) of the traveler 602 (e.g., the additional passenger) based on the captured one or more images of the traveler 602. As previously stated, the identity of the traveler 602 may be obtained in a multi-step process.

In embodiments, the vehicle system 200 may detect the identity of the traveler 602 by comparing the one or more images of the traveler 602 that are captured by the camera 104 with data stored in the one or more memory modules 206 of the vehicle system 200. For example, as previously stated, the one or more memory modules 206 may store data related to the traveler's name, age, images of the traveler 602 from various angles, voice characteristics of the traveler 602, and so forth.

In embodiments, the one or more processors 202 may perform a comparison operation between the facial characteristics included in the captured one or more images of the traveler 602 and the images of the traveler 602 that are stored in the one or more memory modules 206. For example, the comparison operation may include the one or more processors 202 determining whether facial characteristics of the traveler 602 that are included in the one or more captured images have a threshold level of similarity with the images of the traveler 602 stored in the one or more memory modules 206. If the similarity threshold is satisfied, the one or more processors 202 may access a profile that is specific to the traveler 602. Alternatively, a similar comparison operation may be performed by one or more devices that are external to the vehicle system 200, e.g., the server 218. Upon completion of the comparison operation, the server 218 may access a profile specific to the traveler 602 and communicate data specific to the traveler 602 to the vehicle system 200 via the communication network 216. Alternatively or additionally, various other external devices (working in conjunction with the server 218 and/or the vehicle system 200) may perform the comparison operation.

Thereafter, in embodiments, the vehicle system 200 may retrieve one or more voice characteristics (e.g., additional voice characteristics) of the additional passenger based on the identification of the additional passenger. For example, the one or more processors 202 of the vehicle system 200 may retrieve one or more voice characteristics that are specific to the traveler 602 upon the one or more processors 202 determining the identity of the traveler 602, as described above. In embodiments, the one or more processors 202 may retrieve various voice characteristics such as pitch, speech rate (e.g., speed of speech), tone, texture, intonation, loudness (e.g., a typical decibel range of an individual), and so forth, from the data stored in the one or more memory modules 206 (e.g., associated with the database described above). It is contemplated that other voice characteristics may also be retrieved. Alternatively or additionally, the vehicle system 200 may receive these voice characteristics (e.g., specific to the traveler 602) from the server 218 via the communication network 216.

Next, in embodiments, the vehicle system 200 may select a different operating condition for an additional sensor (e.g., the microphone 106) of the vehicle 100 based on the one or more additional voice characteristics of the passenger (e.g., the traveler 602). In embodiments, the one or more processors 202 may communicate with the microphone 106 via the communication path 204 of the vehicle system 200 and select a particular setting for the microphone 106 based on the retrieved voice characteristics of the traveler 602. In embodiments, these characteristics may include the pitch, tone, speech rate (e.g., speed of speech), intonation, loudness, and so forth. For example, the voice characteristics of the traveler 602 may indicate that his speech rate is low and that he has a tendency to speak softly. Additionally, the traveler 602 may have a low pitched voice.

It is noted that, in embodiments, the voice characteristics retrieved by the one or more processors 202 may include numerical values for each of speech rate, pitch, tone, intonation, loudness, and so forth. As such, in embodiments, the one or more processors 202 may select an operating condition for the microphone 106 that corresponds to a pitch value (or pitch value range) that is specific to the voice pitch of the traveler 602. It is noted that, in embodiments, the selection of the operating condition of the microphone 106 may occur automatically, in real time, and without user intervention. Alternatively, in embodiments, the one or more processors 202 may select an operating condition for the microphone 106 based a combination of one or more of the pitch value, tone value, loudness value (among other voice characteristics) that are stored in a profile that is specific to the traveler 602. In embodiments, one or more voice characteristics may be analyzed by the vehicle system 200, simultaneously or sequentially, to select an operating condition.

Thereafter, in embodiments, the microphone 106 may detect, by the additional sensor (e.g., the microphone 106) that operates in the different operating condition, voice data specific to the additional passenger. Specifically, the microphone 106, which may be selected to function in an operating condition that corresponding to a pitch value associated with the traveler 602. For example, if the traveler 602 has a low pitched voice (which may correspond to a low pitch value), a setting of the microphone 106 corresponding to this pitch value may be set. In other embodiments, the microphone 106 may be set to function in an operating condition corresponding to a speech rate of the traveler 602. For example, as stated above, the retrieved voice characteristics of the traveler 602 may indicate that the traveler 602 has a tendency to speak very slowly (which may correspond to a low speech rate value). As such, in this embodiment, the microphone 106 may be set to function in an operating condition such that the microphone 106 detects the voice of the traveler 602 in intervals that are longer than the intervals for, e.g., the driver 402. In other words, the traveler 602 may be set to detect sounds emerging from the traveler 602 within a large or drawn out time interval. It is further noted that the one or more processors 202 may also be configured to analyze the sounds emerging from the traveler 602 at relatively longer time intervals in order to ensure that all of the content included in the sounds emerging from the traveler 602 are adequately analyzed.

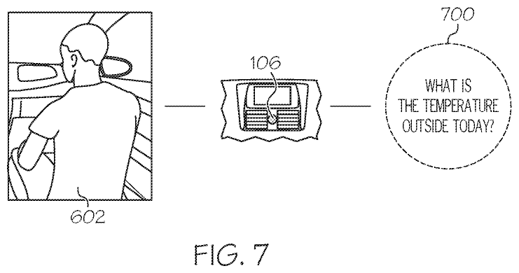

In FIG. 7, another example of the real time operation of the microphone 106 is depicted. Specifically, after the one or more processors 202 select a different operating condition for the microphone 106 based on the voice characteristics of the traveler 602 (e.g., speech rate value, pitch rate, and/or other characteristics), the microphone 106 may detect voice data such as “What is the temperature outside today” (Question 700), which may be an instruction to the vehicle system 200 to provide weather related information to the traveler 602, e.g., weather information of a city. As the setting of the microphone 106 corresponds with the voice characteristics of the traveler 602, the vehicle system 200 will be able to accurately capture the voice data from the traveler 602, effectively analyze the captured data, and perform an action (e.g., initiate a call to a friend). Additionally, the vehicle system 200 may also have the functionality to partially mute or filter sounds that are extraneous the question of the traveler 602, e.g., traffic noises, vehicle horns, and so forth. The vehicle system 200 may prevent these extraneous sounds from being detected by the microphone 106.

It should now be understood that the embodiments described herein are directed to methods and systems that are configured to detect passenger voice data based on vehicle operating conditions that are selected based on passenger voice characteristics. The system includes a sensor, an additional sensor, a processor (each of which is included as part of the vehicle), and one or more non-transitory memory modules communicatively coupled to the processor of the vehicle and configured to store machine-readable instructions. These machine-readable instructions, when executed by the processor, cause the processor to obtain, using the sensor operating in associated with the processor, image data associated with a passenger in the vehicle, obtain an identification of the passenger based on the image data, retrieve one or more voice characteristics of the passenger based on the identification, select, based the image data, an operating condition for the additional sensor of the vehicle based on the one or more voice characteristics of the passenger, and detect, by the additional sensor that operates in the operating condition, voice data specific to the passenger

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method implemented by a computing device of a vehicle, the method comprising:
obtaining, using a sensor operating in association with the computing device, image data associated with a passenger in the vehicle;
obtaining an identification of the passenger based on the image data;
retrieving one or more voice characteristics of the passenger based on the identification;
selecting, by the computing device, an operating condition for an additional sensor of the vehicle based on the one or more voice characteristics of the passenger; and
detecting, by the additional sensor that operates in the operating condition, voice data specific to the passenger.

2. The method of claim 1, further comprising:
obtaining additional image data associated with an additional passenger in the vehicle;
obtaining additional identification of the additional passenger based on the additional image data;
retrieving one or more additional voice characteristics of the additional passenger based on the identification of the additional passenger;
selecting, by the computing device, a different operating condition for the additional sensor of the vehicle based on the one or more additional voice characteristics of the additional passenger; and
detecting, by the additional sensor that operates in the different operating condition, additional voice data specific to the additional passenger.

3. The method of claim 2, wherein the one or more voice characteristics of the passenger and the one or more additional voice characteristics of the additional passenger include pitch, tone, or speech rate.

4. The method of claim 2, wherein the different operating condition of the additional sensor includes a microphone setting corresponding to a speech rate value associated with the additional passenger.

5. The method of claim 1, wherein the sensor is a camera and the additional sensor is a microphone.

6. The method of claim 1, wherein the operating condition of the additional sensor includes a microphone setting corresponding to a speech rate value associated with the passenger.

7. The method of claim 2, wherein the one or more voice characteristics of the passenger and the one or more additional voice characteristics of the additional passenger are stored locally in a database included in the vehicle, and wherein the one or more voice characteristics of the passenger and the one or more additional voice characteristics of the additional passenger are included as part of a profile accessible by the computing device.

8. The method of claim 2, wherein the one or more voice characteristics of the passenger and one or more additional voice characteristics of the additional passenger are stored in a server external to the vehicle, and wherein the one or more voice characteristics of the passenger and the one or more additional voice characteristics of the additional passenger are included as part of a profile accessible by the computing device.

9. The method of claim 8, further comprising retrieving, prior to selecting the operation condition for the additional sensor, the one or more voice characteristics of the passenger from the server external to the vehicle.

10. A vehicle comprising:
a sensor;
an additional sensor;
a processor configured to:
obtain, using the sensor operating in associated with the processor, image data associated with a passenger in the vehicle;
obtain an identification of the passenger based on the image data;
retrieve one or more voice characteristics of the passenger based on the identification;
select, based the image data, an operating condition for the additional sensor of the vehicle based on the one or more voice characteristics of the passenger; and
detect, by the additional sensor that operates in the operating condition, voice data specific to the passenger.

11. The vehicle of claim 10, wherein the processor is further configured to:
obtain, using the sensor operating in association with the processor, additional image data associated with an additional passenger in the vehicle;
obtain an additional identification of the additional passenger based on the additional image data;
retrieve one or more additional voice characteristics of the additional passenger based on the identification of the additional passenger;
select a different operating condition for the additional sensor of the vehicle based on the one or more voice characteristics of the additional passenger; and
detect, using the additional sensor that operates that operates in the different operating condition, additional voice data specific to the additional passenger.

12. The vehicle of claim 11, wherein the one or more voice characteristics of the passenger and the one or more voice characteristics of the additional passenger include pitch, tone, or speech rate.

13. The vehicle of claim 11, wherein the different operating condition of the additional sensor includes a microphone setting corresponding to a speech rate value associated with the additional passenger.

14. The vehicle of claim 10, wherein the sensor is a camera and the additional sensor is a microphone.

15. The vehicle of claim 10, wherein the operating condition of the additional sensor includes a microphone setting corresponding to a speech rate value associated with the passenger.

16. The vehicle of claim 11, wherein the one or more voice characteristics of the passenger and the one or more voice characteristics of the additional passenger are stored locally in a database included in the vehicle, and wherein the one or more voice characteristics of the passenger and the one or more voice characteristics of the additional passenger are included as part of a profile accessible by the processor.

17. The vehicle of claim 11, wherein the one or more voice characteristics of the passenger and one or more additional voice characteristics of the additional passenger are stored in a server that is external to the vehicle, and wherein the one or more voice characteristics of the passenger and the one or more additional voice characteristics of the additional passenger are included as part of a profile accessible by the processor.

18. The vehicle of claim 17, wherein the processor is configured to retrieve, prior to selecting the operation condition for the additional sensor, the one or more voice characteristics of the passenger from the server external to the vehicle.

19. A method comprising:
obtaining, using a sensor, image data associated with a passenger in a vehicle;
obtaining an identification of the passenger based on the image data;
retrieving one or more voice characteristics of the passenger based on the identification;
selecting, by a computing device, an operating condition for an additional sensor of the vehicle based on the one or more voice characteristics of the passenger;
detecting, by the additional sensor that operates in the operating condition, voice data specific to the passenger;
obtaining additional image data associated with an additional passenger in the vehicle;
obtaining additional identification of the additional passenger based on the additional image data;
retrieving one or more additional voice characteristics of the additional passenger based on the identification of the additional passenger;
selecting, by the computing device, a different operating condition for the additional sensor of the vehicle based on the one or more voice characteristics of the additional passenger; and
detecting, by the additional sensor that operates in the different operating condition, additional voice data specific to the additional passenger.

20. The method of claim 19, wherein the one or more voice characteristics of the passenger and the one or more additional voice characteristics of the additional passenger are based on pitch, tone, or speech rate.
